(19) United States
(12) Patent Application Publication
(10) Pub. No.: US 2008/0106625 A1
(43) Pub. Date: May 8, 2008

(54) MULTI IMAGE STORAGE ON SENSOR

(76) Inventors: John N. Border, Walworth, NY (US); John F. Hamilton, Rochester, NY (US); John T. Compton, LeRoy, NY (US)

Correspondence Address: Pamela R. Crocker;Patent Legal Staff, Eastman Kodak Company, 343 State Street, Rochester, NY, 14650-2201, US

(21) Appl. No.: 11/557,217

(22) Filed: Nov. 7, 2006

(51) Int. Cl. H04N 5/335

(52) U.S. Cl. 348/296; 348/E05.091

(57) ABSTRACT

An image sensor includes a plurality of pixels with each pixel having a photosensitive area that captures a sequence of at least two light exposures by accumulating photon-induced charge for each exposure; at least two charge storage areas each of which is associated respectively with one of the sequence of light exposures into which the accumulated charge for each exposure is transferred sequentially; and at least one amplifier that is associated with at least one of the charge storage areas.

### FIELD OF THE INVENTION

The invention relates generally to the field of CMOS image sensors and, more particularly, to such sensors that capture a sequence of images respectively in two or more floating diffusions.

### BACKGROUND OF THE INVENTION

Solid-state image sensors are now used extensively in many types of image capture applications. The two primary image sensor technologies utilized are Charge Coupled Devices (CCD) and complimentary metal oxide semiconductor (CMOS) devices. Both are basically a set or array of photodetectors that convert incident light into an electrical signal that can be readout and used to construct an image correlated to the incident light pattern. The exposure or integration time for the array of photodetectors can be controlled by well-known mechanisms such as a mechanical shutter or an electrical shutter. The electrical signal represents the amount of light incident upon the individual photodetectors in the array of photodetectors on the image sensor.

Image sensor devices, such as a CCD that integrate charge created by incident photons, have dynamic range limited by the maximum amount of charge that can be collected and held in a given photodetector. For example, for any given CCD, the maximum amount of charge that can be collected and detected in an individual photodetector is proportional to the photodetector area. Thus, for a commercial device used in a megapixel digital still camera (DSC), the maximum amount of charge (Vₛₐₜ) that can be collected and held in a given photodetector is typically on the order of 5,000 to 20,000 electrons. If the incident light is very bright and more electrons are created than can be held in the photodetector, the photodetector is saturated and the excess electrons are extracted by an anti-blooming mechanism in the photodetector. Hence, the maximum detectable signal level is limited to the Vₛₐₜ of the photodetector.

Another important measure of an image sensor is the dynamic range (DR), which is defined as

DR=Vₛₐₜ/SNL

Wherein SNL is the sensor noise level. Due to the physical limitations on photodetector area limiting Vₛₐₜ, much work has been done in CCDs to decrease SNL to very low levels. Typically, commercial megapixel DSC devices have a dynamic range of 1000:1 or less.

CCD image sensors are well known in the art and thus are not described herein. An exemplary disclosure can be found in U.S. Pat. No. 5,272,535 titled “Image Sensor with Exposure Control, Selectable Interlaced, Pseudo Interlaced or Non-Interlaced Readout and Video Compression”, issued to Elabd of Sunnyvale, Calif., and assigned to Loral Fairchild Corporation, Syosset, N.Y., December 1993.

Unlike CCD image sensors, a CMOS image sensor can be integrated with other camera functions on the same chip ultimately leading to a single-chip digital camera with very small size, low power consumption and additional functionality. The integration of processing and image capture coupled with high frame rate capability of CMOS image sensors enable efficient implementations of many still imaging and video imaging applications. A drawback, however, is that CMOS image sensors generally include lower DR and higher SNL than CCDs due to their high readout noise and non-uniformity.

The same limitations on DR exist for CMOS devices as on CCDs. Vsat is limited by the amount of charge that can be held and isolated in the photodetector and excess charge is lost. This can become even more problematic with CMOS compared to CCD due to additional circuitry in the form of active components such as analog-to-digital converters, timing circuits and other custom circuitry such as “system on a chip” that are associated with the photodetector that further limits the area available for the photodetector. CMOS devices also use a low voltage supply which increases the impact of thermally created noise. In addition, the active components on CMOS devices, that are not present on CCDs, provide a much higher noise floor on CMOS devices compared to CCDs. This is due to higher temporal noise as well as possibly quantization noise from the on-chip analog-to-digital converter.

Multiple exposures are a well-known photography technique for reducing the impact of noise. In state-of-the-art film cameras, it is possible to expose a single frame of film several times in succession by preventing the film from advancing by mechanical means. This multiple exposure option enables the photographer to solve a number of difficulties encountered when the lighting is not optimal, besides being able to create special effects. However, creating a multiple exposure photograph with a digital camera by repeatedly exposing the sensor to light is problematic, due to noise buildup on the sensor. Instead, to produce a multiple exposure image with a digital camera, the photographer is expected to expose a sequence of images and then combine them using a simple sum approach such as is provided by image-processing software such as Photoshop, available from Adobe Systems Incorporated, of San Jose, USA. An example of this combining technique is provided in an article at the following Internet website: http://www.dpreview.com/leam/Image_Techniques/Double_Exposures_{—}01.htm. This approach does have limitations in that the image processing is typically done on rendered images which have been color corrected and compressed which when added together can produce artifacts.

A more complicated use of the multiple exposure technique is when images are combined to increase depth of field. In this case, the photographer wishes to keep the aperture at minimal size to provide a large depth of field but the flash equipment is not powerful enough to provide correct exposure with the small aperture. It is possible in this case to increase the exposure time and to program the flash to fire several times. However, the combination of the increased exposure time and the time required for the flash to recharge between firing increases the time for thermally generated noise to build up on the image sensor resulting in a noisy image. Another example where it is critical to add light in linear fashion is when the scene is lit simultaneously from indoors and from outdoors, for example when there is a window in the image. In this case it is customary to shoot several images by repeated exposure of a single frame: with the window open, with the window closed, and with and without flash. In the analog case, all the images are thus linearly added on to the single multiply exposed frame. However, in the digital case, combining such differently lit images using image-processing software after they have been captured digitally and rendered, cannot be done in a linear fashion for the reasons mentioned above. Likewise, adding the images directly on the sensor is not possible due to noise considerations, as mentioned above.

Image combination has also been proposed to alleviate the problem of the limited dynamic range of digital camera image sensors. In high contrast scenes, the dynamic range of the camera sensor is often not adequate to provide detail for both dark and light portions of the image, for images captured on CCDs or CMOS devices. In U.S. Pat. No. 6,177,958 by Anderson, after a high contrast scene is detected, the image is captured twice, at different exposures. The bright image and the dark image are then combined to increase the dynamic range in the digital image. A number of methods for combining the two images are described. These methods include: (1) determining an offset to achieve spatial alignment and aligning the images on a pixel-by-pixel basis, (2) determining common areas of the two images and adjusting the exposure overlapping areas so that the common areas are equal in brightness, (3) selecting pixels form the dark image where the pixels are below the darkest area of the exposure overlapped area, or (4) selecting pixels from the light image where the pixel is above the brightest area of the exposure overlapped area. In all cases, the bright and dark images are combined non-linearly, under the assumption that the images being combined are of essentially the same scene. Similar solutions are presented in U.S. Pat. No. 6,011,251 to Dierickx, et al., U.S. Pat. No. 5,247,366 to Ginosar, et al., U.S. Pat. No. 5,144,442 to Hilsenrath, et al., and U.S. Pat. No. 4,647,975 to Alston, et al. Additional solutions are found in World IPO 0 113 171 to Crawford, et al., and European Patents 0 982 983 to Inagaki, et al., and 0 910 209 to Yoneyama, et al. These patents disclose various methods of increasing image dynamic range, by combining images of a scene, generally taken at significantly different exposures, in such a way as to enhance the darkest and brightest components of the image. Documents referred to above are hereby incorporated by reference.

CMOS sensors are well suited to multiple image capture in that CMOS sensors can operate at very fast frame rates. Recently developed CMOS image sensors are read out non-destructively and in a manner similar to a digital memory and can thus be operated at very high frame rates. Several high speed CMOS Active Pixel Sensors have been recently reported. In “A High Speed, 500 Frames/s, 1024×1024 CMOS Active Pixel Sensor”, Krymski et al. describes a 1024×1024 CMOS image sensor that achieves 500 frames per second. Stevanovic et al. describes in “A CMOS Image Sensor for High Speed Imaging” a 256×256 sensor achieving 1000 frames per second. In “A 10,000 Frames/s 0.18 ∥m CMOS Digital Pixel Sensor with Pixel-Level Memory”, Kleinfelder et al. describes a 352×288 CMOS Digital Pixel Sensor achieving 10,000 frames per a second. What is needed is a method for capturing images at very fast frame rates without increasing the SNL and wherein the images can be accessed in a way that enables image processing to achieve the desired effects.

In US Patent Publication 2003/0103158, Barkan describes a multiple image capture method which combines an image capture apparatus comprising a sensor for capturing raw image data, an image buffer for storing said captured raw image data, an image processor for processing said captured data into a displayable image file and a memory for storing said image file, the apparatus further comprising an image combiner associated with said image buffer for performing linear combinations between different captures of said raw image data, therefrom to form multiple exposure images. The solution disclosed by Barkan is to retain the raw image in an image buffer and to subsequently add additional images, as captured by the image sensor, pixel by pixel by a linear image combiner to the raw image in the image buffer. When the desired multiple exposure image is achieved, the image may be transferred from the image buffer to another section of the buffer memory, or rendered into a viewable image and stored in the main memory.

In U.S. Pat. No. 7,009,636, Liu discloses a method for multiple image exposure on an image sensor to improve the signal to noise ratio (SNR), improve the dynamic range and avoid motion blur in the digital image. The method disclosed by Liu enables the electrical signal on the photodetectors to be estimated to determine whether the photodetector is saturated or whether motion has occurred. If the photodetector is not saturated or motion has not occurred, then the image sensor can be exposed to an additional exposure. If the photodetector is saturated or motion is detected, then the exposure is ended.

In U.S. Pat. No. 7,054,041, Stevenson describes an image sensor with a second depletion region underneath the readout capacitor electrode that enables the electrical signal from the photodetector to be read multiple times without affecting the stored electrical signal.

In U.S. Pat. No. 5,867,215, Kaplan discloses an image sensor with multiple storage wells per photodetector. The multiple storage wells are connected so that the electrical signal generated by the photodetector sequentially fills the multiple storage wells thereby increasing the Vsat of the individual photodetectors and increasing the dynamic range of the image sensor.

Therefore, there exists a need for an image sensor that can operate at very fast frame rates to capture multiple sequential images in such a manner that the images can be combined to improve image characteristics such as dynamic range, image stabilization and imaging in low light conditions.

### SUMMARY OF THE INVENTION

The present invention is directed to overcoming one or more of the problems set forth above. Briefly summarized, according to one aspect of the present invention, the present invention resides in an image sensor comprising a plurality of pixels, each pixel comprising: a) a photosensitive area that captures a sequence of at least two light exposures by accumulating photon-induced charge for each exposure; b) at least two charge storage areas each of which is associated respectively with one of the sequence of light exposures into which the accumulated charge for each exposure is transferred sequentially; and c) at least one amplifier that is associated with at least one of the charge storage areas.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention includes the advantages of digital image stabilization, increased sensitivity, elimination of motion blur, extended dynamic range and autofocus.

### BRIEF DESCRIPTION OF THE DRAWINGS

FIG. 1 is a top view of the image senor of the present invention;

FIG. 2 is a schematic diagram of a typical pixel of FIG. 1;

FIG. 3 is an alternative embodiment of FIG. 2;

FIG. 4 is still yet another alternative embodiment of FIG. 2;

FIG. 5 is a digital camera for illustrating a typical commercial embodiment of the present invention to which the ordinary consumer is accustomed;

FIG. 6 is a cross sectional view of FIG. 3 illustrating the dopings at the same depth; and

FIG. 7 is a cross sectional view of FIG. 3 illustrating the dopings at different depths.

### DETAILED DESCRIPTION OF THE INVENTION

Before discussing the present invention in detail, it is instructive to note that the present invention is preferably used in, but not limited to, a CMOS active pixel sensor. Active pixel sensor refers to an active electrical element within the pixel, more specifically an amplifier. CMOS refers to complementary metal oxide silicon type electrical components such as transistors which are associated with the pixel, but typically not in the pixel, and which are formed when the source/drain of a transistor is of one dopant type and its mated transistor is of the opposite dopant type. CMOS devices include advantages on of which is they consume less power.

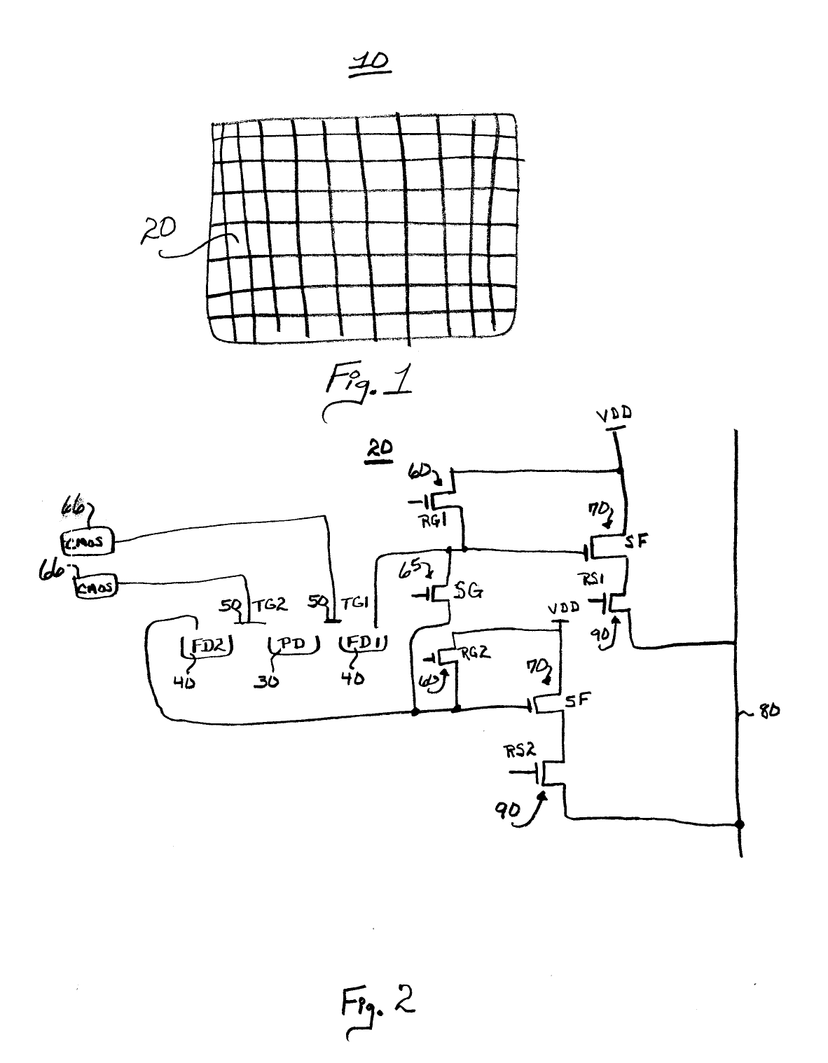

Referring to FIG. 1, there is shown an image sensor 10 of the present invention having a plurality of pixels 20 arranged in a two-dimensional array. Although a two-dimensional array is shown as a preferred embodiment, the present invention is not limited to a two-dimensional array; as is apparent to those skilled in the art, a one-dimensional array may also be used.

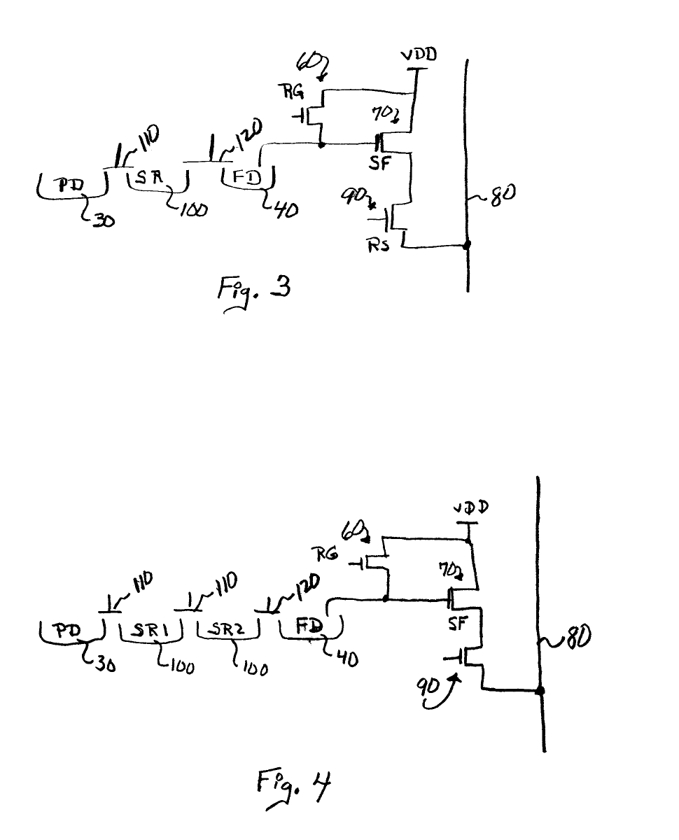

Referring to FIG. 2, there is shown a representative pixel 20 of the present invention. The pixel 20 includes a photosensitive region 30, preferably a photodiode or pinned photodiode, for collecting charge in response to incident light. Preferably, two floating diffusions 40 are electrically connected to the photodiode 30, each by a transfer gate 50, for receiving charge from the photosensitive region 30. In the present invention, the photosensitive region 30 captures a sequence of images and sequentially and respectively transfers the image to each of the floating diffusions 40, which converts the charge to a voltage. Two reset transistors 60 are respectively connected to each floating diffusion 40 for resetting the signal level of the floating diffusion 40 to a predetermined level before the charge is transferred to the floating diffusion 40 from the photosensitive region 30. Optionally, a sharing transistor 65 is connected to each floating diffusion 40 for creating an increased capacitance by combining charge capacitance of the floating diffusions 40.

It is noted for thoroughness that the transfer gates 50 are preferably connected to CMOS transistors 66 for forming control circuitry on the same silicon chip as the pixel array 20 or on a different silicon chip than the array of pixels 20. The CMOS transistors 66 are as described hereinabove.

Two amplifiers 70, preferably source followers, respectively receive the charge from the floating diffusions 40 for amplifying the voltage (unity gain or greater) which is output on an output bus 80 for further processing. Two row select transistors 90 are respectively modulated to select the particular amplifier output 70 to which it is connected for readout.

In operation of the present invention, the transfer gate (TG1) 50 associated with that floating diffusion (FD1) 40 is pulsed to allow charge to flow from the photodiode 30 into the floating diffusion 40; the floating diffusion (FD1) 40 is reset by pulsing its reset gate of the reset transistor (RG1) 60, thereby effectively resetting the photosensitive region 30. The transfer gate (TG1) 50 is turned off and the photosensitive region 30 is allowed to accumulate photon-induced charge for a period of time corresponding to the desired exposure time. At the end of this time, the transfer gate (TG1) 50 is pulsed again to transfer the accumulated charge into the floating diffusion (FD1) 40. This process is then repeated using the other floating diffusion (FD2) 40 and transfer gate (TG2) 50. After the accumulated charge from the second exposure has been transferred to the second floating diffusion (FD2) 40, a sequence of two exposures has been captured in the two floating diffusions 40 and can be read out sequentially as shown in FIG. 2, or simultaneously as will be apparent to those skilled in the art, by using the two amplifiers 70 and row select transistors 90 in a conventional manner as will be readily recognized by those skilled in the art.

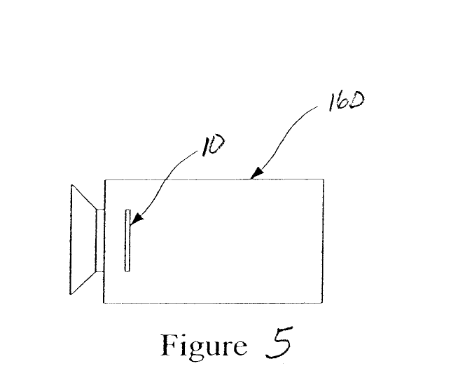

Referring to FIG. 3, in an alternative embodiment, diffusion 100 provides a charge storage region that is connected in series to the photodiode 30 and floating diffusion 40. Charge is transferred from the photodiode 30 into the charge storage region 100 and then to the floating diffusion 40 in sequence by appropriately modulating the gates 110 and 120. The floating diffusion converts the charge to a voltage and the amplifier 70, again preferably a source follower, senses the voltage on the floating diffusion 40 and sends the resultant voltage level to the output bus 80. The reset transistor 60 resets the floating diffusion to a predetermined level, and a row select transistor 90 selects the particular row for readout.

Referring to FIG. 4, there is shown still yet another alternative embodiment. In this embodiment, there is a plurality of charge storage regions 110. The remaining portion of the circuit is as in FIG. 3

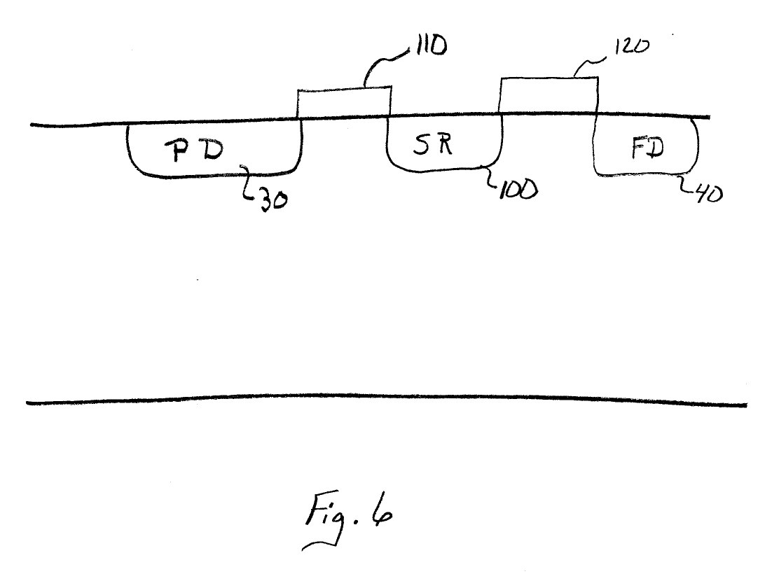

Referring to FIG. 5, there is shown a digital camera 160 having the image sensor 10 of the present invention therein for illustrating a commercial embodiment to which the ordinary consumer is accustomed.

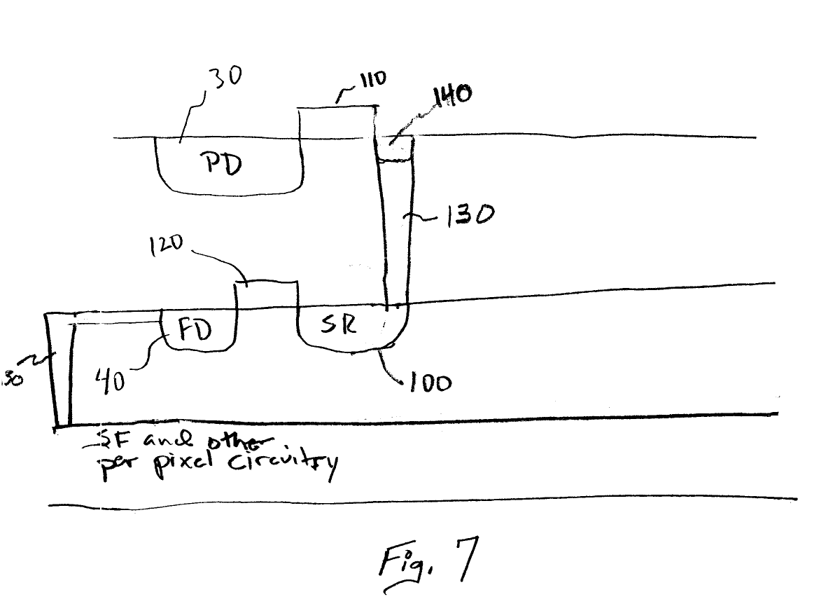

Referring to FIG. 6 (corresponding to FIG. 3), those skilled in the art will recognize that the charge storage areas 100 can be located in the same plane as the photodiode 30 wherein they are located at substantially the same depth or alternately and referring to FIG. 7, the charge storage areas 100 can be located on different planes from the photodiode 30 wherein they are located at substantially different depths. For the case in which the photodiode 30 is located in the same plane as the charge storage areas 100, the area of the photodiode 30 must be reduced to provide area for the charge storage areas 100. By locating the charge storage areas 100 in different planes from the photodiode 30 in a stacked arrangement connected by vertical (and horizontal if desired) metal conductors 130, the area of the photodiode 30 can be made larger thereby allowing the photodiode 30 to gather more light thereby increasing the sensitivity. In FIG. 7, it is noted that diffusion 140 is needed to channel the charge to the conductor 130 and eventually the storage region 100. It is also noted that the amplifier 70 and other associated circuitry are located in the same layer or a different layer (as shown in FIG. 7). In a preferred embodiment, the photodiode 30 is located on one plane, the charge storage areas 100 and the associated circuitry (not shown) such as the analog to digital converters are each located on different planes in a stacked arrangement. It is noted that those skilled in the art will recognize that the structures discussed above can be arranged in different silicon substrates as illustrated in FIG. 7, or the structures can be arranged at different depths within a single silicon substrate.

The invention has been described with reference to a preferred embodiment. However, it will be appreciated that variations and modifications can be effected by a person of ordinary skill in the art without departing from the scope of the invention.

### PARTS LIST

10 image sensor
20 pixels
30 photosensitive region (photodiode or pinned photodiode)
40 floating diffusion
50 transfer gate
60 reset transistor
65 sharing transistor
66 CMOS transistors
70 amplifier
80 output bus
90 row select transistor
100 charge storage region
110 transfer gate
120 transfer gate
130 metal conductor
140 diffusion
160 digital camera

1. An image sensor comprising:
a plurality of pixels, each pixel comprising:
a) a photosensitive area that captures a sequence of at least two light exposures by accumulating photon-induced charge for each exposure;
b) at least two charge storage areas each of which is associated respectively with one of the sequence of light exposures into which the accumulated charge for each exposure is transferred sequentially; and
c) at least one amplifier that is associated with at least one of the charge storage areas.

2. The image sensor as in claim 1, wherein each light exposure represents a distinct image.

3. The image sensor as in claim 1, wherein the charge storage areas are floating diffusions.

4. The image sensor as in claim 3, wherein at least two distinct floating diffusions have different charge capacities.

5. The image sensor as in claim 1, wherein the charge storage areas are arranged substantially at the same depth as the photosensitive area.

6. The image sensor as in claim 1, wherein at least one of the charge storage areas is arranged at a different depth than the photosensitive area.

7. The image sensor as in claim 1, wherein at least two of the charge storage areas are connected to allow accumulated charge to be transferred therebetween.

8. A camera comprising:
an image sensor comprising:
a plurality of pixels, each pixel comprising:
a) a photosensitive area that captures a sequence of at least two light exposures by accumulating photon-induced charge for each exposure;
b) at least two charge storage areas each of which is associated respectively with one of the sequence of light exposures into which the accumulated charge for each exposure is transferred sequentially; and
c) at least one amplifier that is associated with at least one of the charge storage areas.

9. The camera as in claim 8, wherein each light exposure represents a distinct image.

10. The camera as in claim 8, wherein the charge storage areas are floating diffusions.

11. The camera as in claim 10, wherein at least two distinct floating diffusions have different charge capacities.

12. The camera as in claim 8, wherein the charge storage areas are arranged substantially at the same depth as the photosensitive area.

13. The camera as in claim 8, wherein at least one of the charge storage areas is arranged at a different depth than the photosensitive area.

14. The camera as in claim 8, wherein at least two of the charge storage areas are connected to allow accumulated charge to be transferred therebetween.
